(19) United States
(12) Patent Application Publication
(10) Pub. No.: US 2002/0047340 A1
(43) Pub. Date: Apr. 25, 2002

(54) Motor/ generator using helium for thermal cooling

(76) Inventor: David W. Lewis, Charlottesville, VA (US)

Correspondence Address: Leo J. Aubel, 111 Rivershire Lane, Lincolnshire, IL, 60069, US

(21) Appl. No.: 09/906,181

(22) Filed: Jul. 16, 2001

Related U.S. Application Data
(60) Provisional application No. 60/218,537, filed on Jul. 17, 2000.

(51) Int. Cl. H02K 9/00

(52) U.S. Cl. 310/52

(57) ABSTRACT

A system and method for providing thermal distribution to a machine including rotating elements, such as flywheels and gears, enclosed in an air-tight housing environment; the system and method provide heat dissipation to the machine housing, frames. Helium introduced into the housing provides the cooling medium. In the preferred embodiment, helium at above atmospheric pressure is provided in the housing.

This application claims the priority filing date of provisional patent application 60/218537 filed on Jul. 17, 2000 in the name of the same inventor, David W. Lewis.

### BACKGROUND OF INVENTION

It is known that flywheel energy storage devices such as disclosed in U.S. Pat. No. 5,398,571 issued to David W. Lewis become more efficient as their speeds are increased since energy storage quantity is a function of the product of the square of the speed and the moment of inertia of the rotating mass. However, as the speed of the rotating mass increases, the windage losses also increase causing the temperature of the flywheel to increase. The increase in temperature of the flywheel has several deleterious effects on the electrical windings, on the mechanical strength of the unit, on the bearings employed, on any electrical or electronic components being subjected to said temperature increase, and other components and elements of the system.

One means employed in the prior art for reducing the windage loss, and thereby reducing the temperature increase in the system, is by evacuating the air from the system, i.e., providing a vacuum. However, the vacuum resulting by this approach has a related negative effect in that there is reduced air to carry heat from the rotating elements to the outer housings, frames or other thermal capacitance.

### SUMMARY OF THE INVENTION

This invention provides method and system for providing thermal cooling to the rotating elements of a motor/generator system by providing helium to the housing wherein the rotating elements are mounted. Helium has the special attribute of having good thermal capacitance and low frictional drag. The preferred embodiment utilizes helium under pressure as the coolant medium.

The foregoing features and advantages of the present invention will be apparent from the following more particular description of the invention. The accompanying drawings, listed herein below, are useful in explaining the invention.

### BRIEF OF THE DRAWINGS

FIG. 1 shows an embodiment of an apparatus including a rotating element in the form of a flywheel wherein the inventive concept is utilized; and

FIG. 2 is an isometric view of FIG. 1, to more clearly show the housing or chamber and the evacuating pump and an input valve for controlling the helium in the housing.

### DESCRIPTION OF THE INVENTION

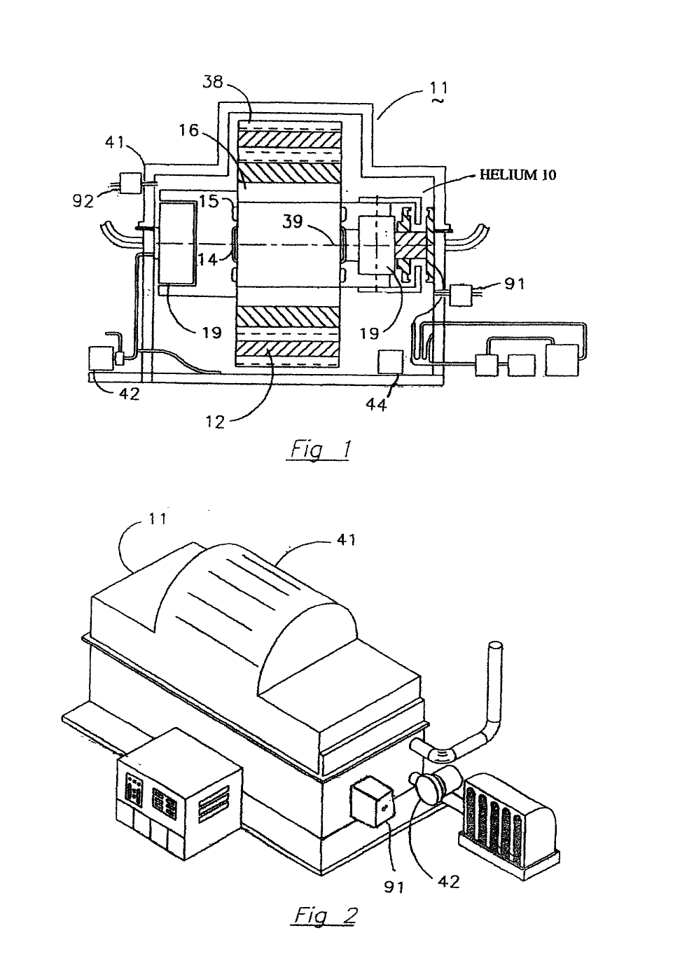

The present invention is related to the above mentioned U.S. Pat. No. 5,398,571 issued on Mar. 21, 1995 to David W. Lewis titled “Flywheel Storage System With Improved Magnetic Bearings” in that it is directed to providing better cooling to a system of the type disclosed therein. The FIGS., 1 and 2 of the present application, are patterned after FIGS. 1 and 2, of U.S. Pat. No. 5,398,571. It should however be understood that the invention is applicable generally to systems having rotating elements and is not limited to flywheel material composition and the specific gear types or motor/generator described in U.S. Pat. No. 5,398,571.

FIGS. 1 and 2, herein show an electrical energy storage system 11 substantially as disclosed in said U.S. Pat. No. 5,398,571, but with modifications in accordance with the present invention. For present purposes, only the pertinent components of the electrical energy storage system 11, as relate to the present invention, will be referred to in detail. As described in U.S. Pat. No. 5,398,572, system 11 is designed to act reversibly as either a motor or a generator depending upon whether electric power is being transferred into or out of the storage system. The motor/generator 14 which comprises the means for transferring electrical energy into and out of the storage system 11 includes electromagnets 15, permanent magnets 16 and magnetic bearings 19. The electromagnet and permanent magnets are integrated into the structure of the flywheel 12. The rotating elements of the generator 14, and associated structures comprise the rotor element 38. The structural components, frames and supports as well as the spacings within the housing 41 are selected to assure the alignment of the rotating elements and stationary elements 16, as indicated at center lines 39 so that minimal clearances are maintained.

The housing 41 forms a closed (air-tight) housing or chamber. In a preferred embodiment of the system, a pump 42, of any suitable known type, evacuates the air from the interior of the housing. Helium gas, indicated at 10, is then pumped into the interior of housing 41 through either one or both valves 91 and 92; helium at a pressure of between about one to two atmospheres has been found preferable. Helium is also useful when it is utilized at partial atmospheric pressure, however helium at the pressure indicated provides better and more efficient cooling.

Helium has a special attribute of having good thermal capacitance; that is, helium will absorb heat from a heated environment and disperse the heat to a surface which is at a lower temperature. Helium has further attributes in that it has low frictional drag, and is not volatile nor explosive.

The very low molecular weight of helium provides an alternate means for reducing the windage losses of the rotating element of the flywheel system and simultaneously transporting excess heat emanating from the various devices which compose the flywheel energy system. Because of the low molecular weight, the windage losses will be less than air even with helium pressure above atmospheric. This increase in pressure will aid in the transfer of heat energy from the rotating elements to the frame, to the containment vessel, and to other elements employed specifically to transfer heat to the surrounding atmosphere.

As is known, hydrogen also has somewhat better thermal qualities than helium. However, the explosive nature of hydrogen is a totally undesired and negative attribute. Further, the differential in thermal effects between hydrogen and helium is less than 10%; and quite importantly helium is inert and non-explosive. In contrast to helium, hydrogen and oxygen create a possibility of explosion or fire. But because helium is inert, regardless of whether there is possible leakage into the housing or out of the housing there is no danger of fire or explosion. Note that when the system employs helium above atmospheric pressure within the housing, any leakage can be easily detected and corrected.

As mentioned above additional benefits in the use of helium versus air rests on the lower density of helium, and therefore lower windage and ventilating losses. Further, the specific heat of helium is many times that of air so that even with less total weight-volume helium will conduct more heat than air. This permits the optimization of the pressure of the helium for different types of flywheels, whether made from metal, or carbon fiber filaments, special castings of metal or plastics, or other threaded construction forms. The environment surrounding the flywheel can thus be adjusted as a function of the speed of the flywheel and the material from which it is constructed.

In the helium environment, the life of the insulation of the electrical windings in the housing is increased and maintenance expenses decreased because of the absence of moisture, oxygen and other contaminants. By porting the dry helium into the housing 41 until atmospheric or higher pressure exists within housing 41, condensation of moisture from intruding atmospheric air will be avoided. Also, the ratings of the electrical windings of the motor/generator are increased by as much as 30% when employing helium in lieu of air, and simultaneously the efficiency of the machine is increased by the reduction of windage losses.

In many applications, the rotating element 38 includes protrusions or other outstanding surfaces which provide drag and hence movement, i.e., circulation of the helium gas within the housing 41. As indicated above, when the helium gas 10 circulates it will more efficiently absorb the heat from the rotating element and transfer the heat to the surface of the housing 41. In a structure wherein the rotating element 38 is too smooth to cause significant circulation or movement of the helium gas, a fan 44 of any suitable standard design, is mounted in the interior of the housing 41.

While the invention has been particularly shown and described with reference to particular embodiments thereof it will be understood by those skilled in the art that various changes in form and detail may be made therein without departing from the spirit and scope of the invention.

1. A system for effecting thermal distribution from the rotating elements of a motor/generator and associated electrical elements mounted within an enclosed chamber or housing to the surface of the housing and to other heat dispersing members, said system comprising,
a) said housing formed of heat transferring material; and
b) helium gas at a pressure above atmospheric pressure in said housing;
c) gas circulating means for moving said helium within said housing to provide a heat capacitance medium for absorbing heat and transferring said heat to the housing.

2. Apparatus as in claim 1 wherein said pressure is between one and two atmospheres.

3. Apparatus as in claim 1 wherein said housing is evacuated and helium is then pumped into said housing.

4. Apparatus as in claim 1 wherein said housing is only partially evacuated and helium is introduced into said housing.

5. Apparatus as in claim 1 wherein said means for circulating said helium comprises a fan installed within said housing.

6. A system for effecting thermal distribution from the rotating elements of a motor/generator and associated electrical elements mounted within an enclosed housing to the surface of the housing and to other heat dispersing members, said system comprising,
a) said housing formed of heat transferring material;
b) helium gas introduced into said housing;
c) gas circulating means for moving said helium within said housing to provide a heat capacitance medium for absorbing heat and transferring said heat to said housing.

7. A method of cooling a rotating element of a motor or generator consisting of the steps of:
a) mounting the rotating element in an air-tight chamber formed of a material having heat exchanging properties;
b) evacuating air from said chamber;
c) filling said chamber with helium; and
d) circulating the helium within said chamber thereby enabling the helium to absorb heat, and transfer heat to the surface of said chamber.

8. A method as in claim 5 wherein helium under pressure is introduced into said chamber.

9. A method as in claim 5 wherein said chamber is partially evacuated of air and helium is introduced into said chamber.
